(19) United States
(12) Patent Application Publication
(10) Pub. No.: US 2011/0030292 A1
(43) Pub. Date: Feb. 10, 2011

(54) Simulated Stone or Brick Column and Method of Fabricating Same

(75) Inventors: William Stephen Oram, Taylorsville, NC (US); Weldin Wayne Oram, JR., Taylorsville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Arc Technologies, LLC

(21) Appl. No.: 12/858,188

(22) Filed: Aug. 17, 2010

Related U.S. Application Data
(63) Continuation-in-part of application No. 11/435,119, filed on May 16, 2006, now abandoned.

(51) Int. Cl. A47G 29/12; B29C 41/06; B29C 70/58; E04C 3/30; B23P 17/00

(52) U.S. Cl. 52/173.1; 264/310; 264/45.7; 52/314; 29/527.1

(57) ABSTRACT

A simulated stone or brick column is fabricated by a method that involves providing a hollow closed mold that has an inner face in the form of a reverse image of the desired stone or brick surface. A liquid casting material is introduced into the mold and in the mold is rotated about two perpendicular axes so that the casting material coats the inner face of the mold and results in the formation of a hollow column having the external appearance of the desired stone or brick surface. The casting material forms a molded column that has a texture and contour that simulate a stone or brick surface. A mailbox and newspaper tube can be installed in the column.

### CROSS-REFERENCE TO RELATED APPLICATION

The present application is a continuation-in-part of U.S. patent application Ser. No. 11/435,119 filed on May 16, 2006, currently pending, the entire disclosure of which is hereby incorporated herein by reference.

### BACKGROUND OF THE INVENTION

The present invention relates to a simulated stone or brick column which is configured to serve as a support for a plaque, light, or mailbox, or as a fence post.

Columns and posts of the described type are conventionally formed of wood, stone, or brick. Wooden posts quickly deteriorate and become unsightly, while stone or brick posts are expensive to fabricate at their location of use. Also, when such columns or posts are mounted adjacent a roadway, they can cause significant damage if accidentally impacted by an automobile.

It is accordingly an object of the present invention to provide a column or post of the described type, which presents an attractive appearance, which is long lasting, and which is relatively inexpensive to fabricate and maintain.

It is also an object of the present invention to provide a simulated stone or brick column which can be placed adjacent a roadway to support a mailbox and/or newspaper tube, and which is of low weight, and is designed to easily break away from its mounting, to thereby minimize the risk of damage to an automobile which accidentally impacts the column.

It is another object of the present invention to provide a column or post which can be mass produced at a manufacturing facility and then easily mounted as a one-piece unit at its point of use.

It is still another object to provide a column or post of the described type which is highly resistant to deterioration, and yet is of low weight so as to further facilitate its mounting at the intended point of use.

### SUMMARY OF THE INVENTION

The above and other objects and advantages of the invention are achieved by the provision of a simulated stone or brick column which is fabricated by a method which involves providing a hollow closed mold which has a peripheral side wall and opposite end plates, and with at least the peripheral side wall having an inner face which comprises a reverse image of a stone or brick surface. A first liquid casting material is introduced into the mold, and the mold is rotated about two different axes so as to cause the material to coat the inner face of the side wall and the opposite end plates. The first casting material is allowed to cure and harden, and a second liquid casting material is then introduced into the mold and the rotation is repeated. After the second casting material hardens, the mold is opened to permit removal of the molded column. The peripheral side wall of the resulting molded column will thus have an exterior surface in the form of a positive image of the stone or brick surface.

The first liquid casting material thus forms an outer layer of the wall of the resulting molded column, and it is formulated to provide, upon hardening, the realistic look and texture of stone or brick. The second liquid casting material is formulated to provide, upon hardening, an inner wall layer which provides significant tensile strength while adding minimal weight to the resulting column.

In another embodiment, a single liquid casting material is used to rotary-cast the column as a single layer. The casting material can comprise a blend of a polymer resin component, a catalyst component that, when blended with the polymer resin component, initiates an exothermic chemical reaction that ultimately results in the casting material curing and hardening, and a filler component distributed throughout the casting material. The polymer resin component can be one or more of polyester resin or vinyl ester resin, and can include one or more other additives. The catalyst component can comprise methyl ethyl ketone peroxide (MEKP) or the like. The filler component can comprise one or more of inorganic particulate fillers (e.g., calcium carbonate, aluminum trihydrate, or the like), organic particulate fillers (e.g., pulverized pecan shells, wood flour, or the like), or lightweight microballoons or microspheres (e.g., glass microballoons, phenolic resin microballoons, or the like).

The method of the present invention readily lends itself to an embodiment wherein a mailbox may be integrally mounted in the column.

In other embodiments, the resulting molded column can be used as a fence post, with a railing mounted between adjacent posts, or the column can be used to support a plaque with a house number, a light, or the like.

In all of the above embodiments, the column can be easily mounted upon a flat foundation footer at its final point of use, by utilizing an adhesive between the bottom wall of the column and the footer.

### BRIEF DESCRIPTION OF THE DRAWINGS

Some of the objects and advantages of the present invention having been stated, others will appear as the description proceeds, when considered together with the accompanying drawings, in which:

FIG. 1 is a perspective view of a simulated stone mailbox supporting column which embodies the present invention;

FIG. 2 is an exploded perspective view of a step in the fabrication of the mold used to practice the present invention;

FIGS. 3A, 3B, and 3C are fragmentary cross sectional views taken along the line 3-3 of FIG. 2 and illustrating additional steps in the fabrication of the mold;

FIG. 4 is a perspective view of a portion of the interior of the mold of the present invention;

FIG. 5 is a fragmentary sectional view taken along the line 5-5 of FIG. 4;

FIG. 6 is an exploded perspective view of the mold in an inverted orientation;

FIG. 7 is a perspective view of the mold during the step of introducing a first liquid casting material into the mold while it is inverted;

FIG. 8 is a perspective view of the step of rotating the mold about two axes;

FIG. 9 is a fragmentary sectional view taken along the line 9-9 of FIG. 8;

FIG. 10 is a fragmentary perspective view during the step of introducing a second liquid casting material into the mold;

FIG. 11 is a view similar to FIG. 8 and showing the second rotation step;

FIG. 12 is a cross sectional view of the mold during the step of introducing a foam forming material into the mold;

FIG. 13 is an exploded perspective view showing the step of disassembling the mold from the molded column;

FIG. 14 is a cross sectional view of the molded column after the foam forming material has been introduced;

FIG. 14A is a fragmentary enlarged view of the wall of the resulting molded column;

FIG. 15A is a fragmentary perspective view showing the step of applying a rubber-like stencil upon the top portion of the column so as to cover the grout lines of the column;

FIG. 15B is a fragmentary perspective view showing one of the spray painting steps;

FIG. 16A is a fragmentary perspective view showing the step of applying a rubber-like stencil upon two side walls of the column;

FIG. 16B is a perspective view of the spray painting of the side walls of the column;

FIG. 17 is a fragmentary perspective view showing the step of re-assembling the cover and flag of the mailbox;

FIG. 18 is a perspective view illustrating the application of an adhesive to the bottom wall of the column during its mounting upon a foundation footer;

FIG. 19 is a perspective view of the finished column which schematically illustrates its internal construction;

FIG. 20 is a perspective of a second embodiment of the invention in which the molded column serves as a fence post;

FIG. 20A is an exploded view showing the mounting of a railing to one of the fence posts of FIG. 20;

FIG. 21 is a perspective view showing two of four mold wall members joined together in accordance with a further embodiment of the present invention;

FIG. 22 shows threaded studs extending through one mold wall member for attaching a mailbox mold plug having correspondingly threaded inserts;

FIG. 23 is a perspective view showing all four mold wall members joined together;

FIG. 24 shows the completed mold, after attachment of end walls, mounted on a frame in a rotational casting apparatus;

FIG. 25 is a view of one mold end wall showing a rubber plug having a vent for venting gas released in the exothermic reaction of the casting composition during rotational casting;

FIG. 26 shows a simulated stone mailbox column after its removal from the mold; and

FIG. 27 shows the mounting of a mailbox in the opening of the simulated stone mailbox column.

### DETAILED DESCRIPTION OF THE PREFERRED EMBODIMENTS

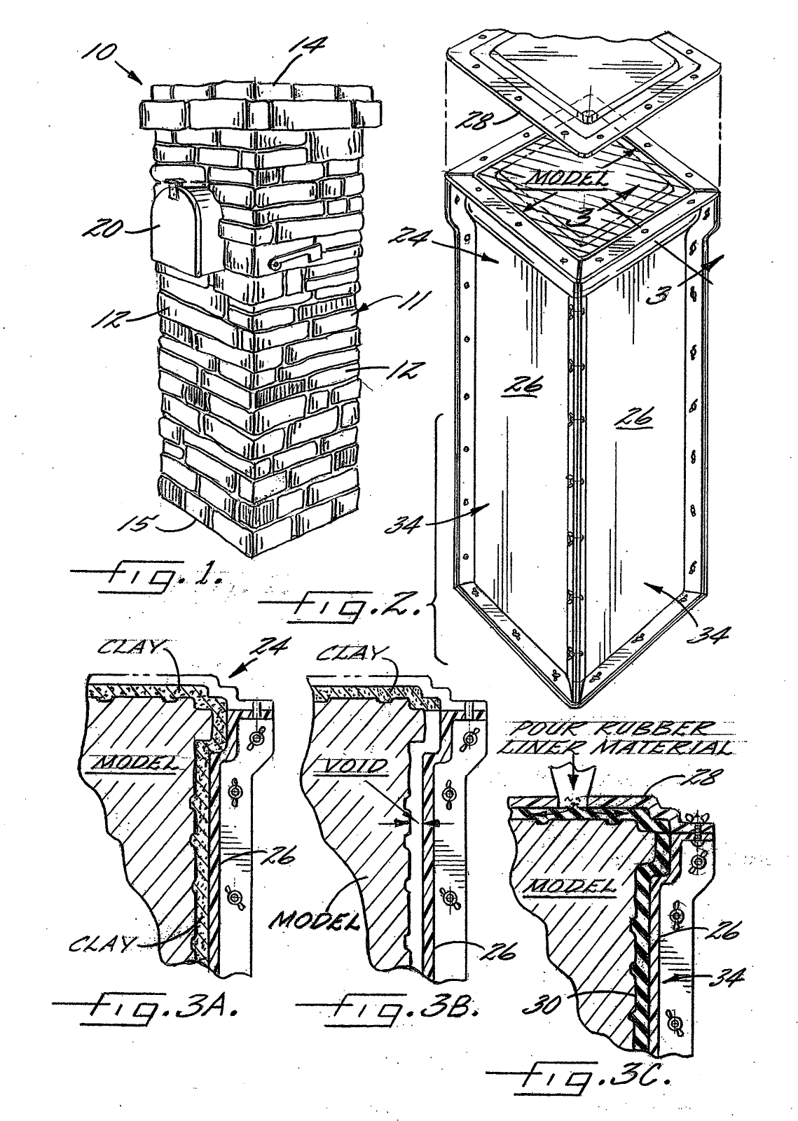

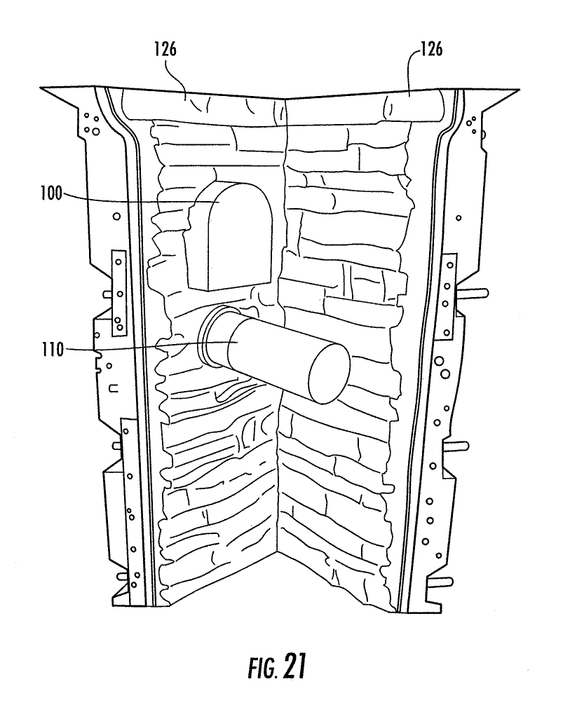

Referring more particularly to the drawings, FIG. 1 illustrates a finished mailbox supporting column which embodies the present invention. The column 10 is of elongate tubular configuration composed of a peripheral side wall 11, an upper end wall 14, and a bottom end wall 15 which are joined together to form a hollow enclosure, note FIG. 14. The peripheral side wall 11 is composed of four peripheral side wall members 12 which form a square when viewed in horizontal cross section, but round or other cross sectional configurations are possible in the practice of the present invention.

The four side wall members 12, the upper end wall 14, and the bottom end wall 15 each comprise an outer layer 16 (note FIG. 14A) of a material which is formulated to provide a realistic look of stone or brick and grout in the finished column. Each of these walls also comprises an inner layer 18 which comprises a mixture of a polymeric resin and fiber strands which is formulated to provide tensile strength while adding minimal weight to the resulting molded column. Also, the outer layer 16 has an outer surface which is shaped to resemble a stone or brick wall with grout between the stones or bricks.

In one preferred embodiment, the column 10 mounts a mailbox 20 which extends through one of the side wall members 12 so that the openable end of the mailbox is accessible from the outside of the column and the rear end portion is within the hollow enclosure formed by the walls of the column. Also, as seen in FIG. 14, the hollow enclosure is partially filled with a foam material 21 so as to surround and support the rear end portion of the mailbox within the enclosure.

The above described support column 10 is preferably fabricated by a molding process which is described in detail in the following paragraphs.

### The Fabrication of the Mold

As a first step in the production process, a mold 24 is fabricated in which the column 10 is molded.

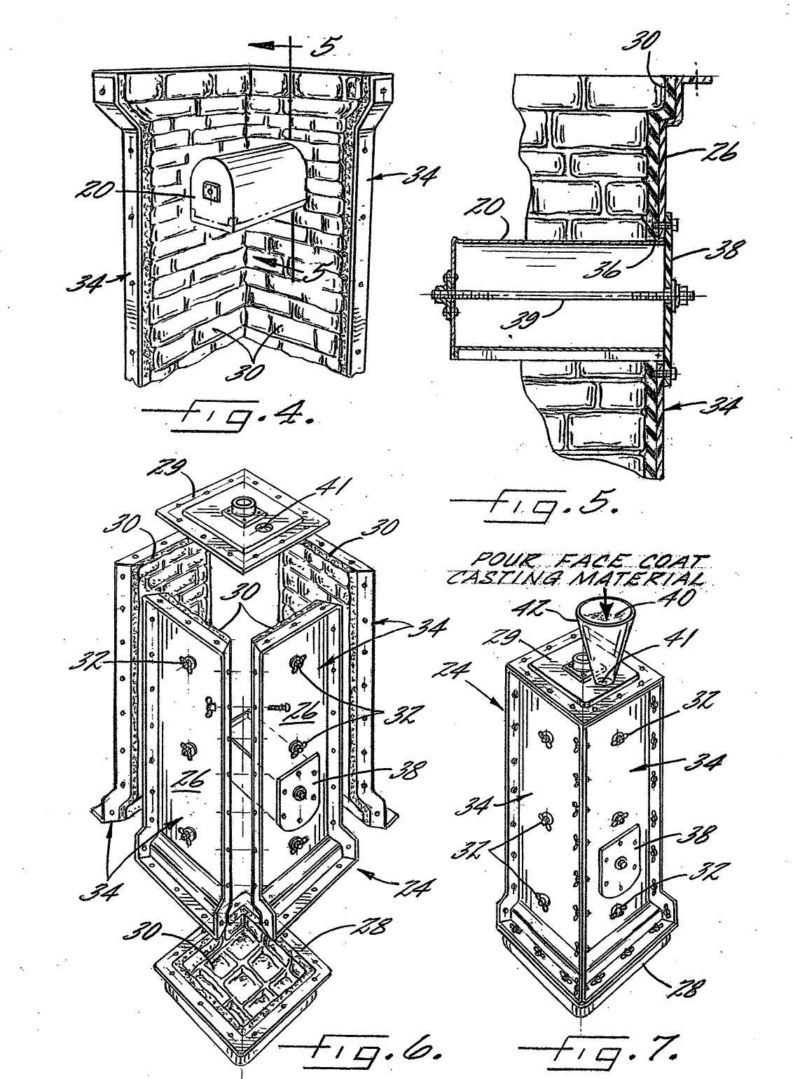

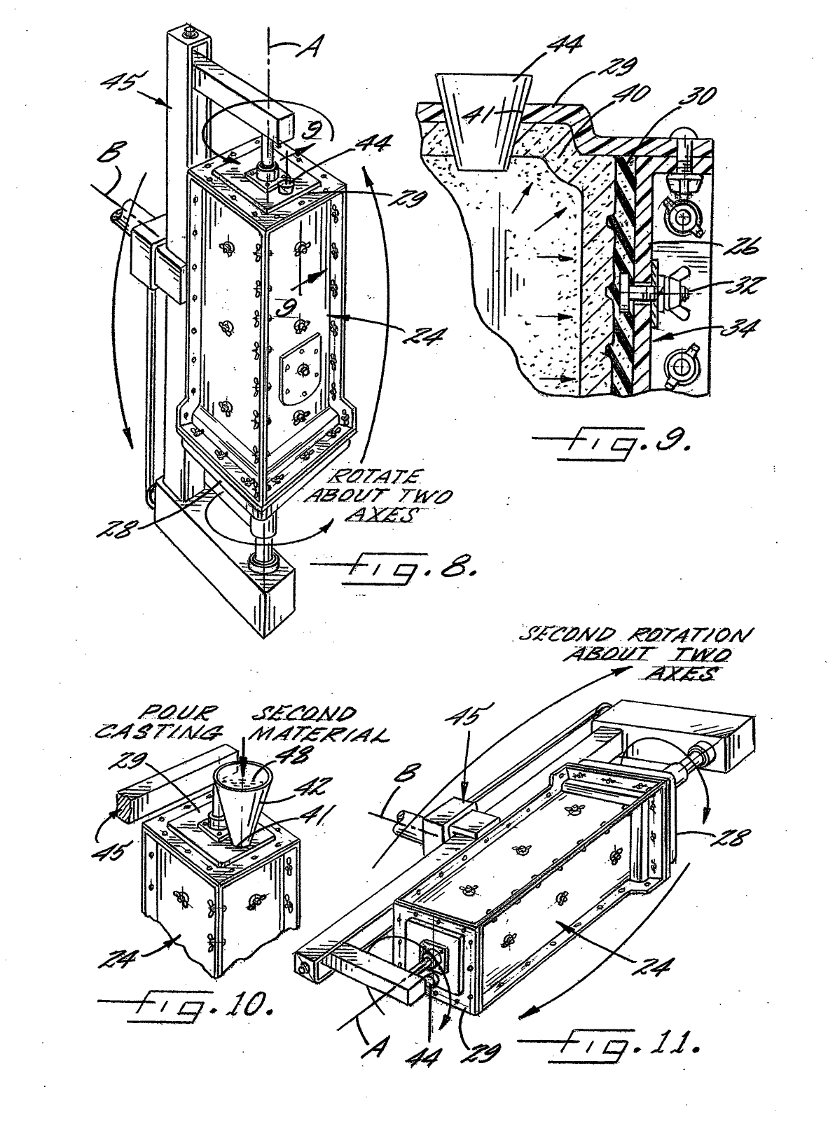

As is illustrated in FIGS. 2 and 3A-3C, the fabrication of the mold 24 begins with the fabrication of a model which embodies the configuration and contoured surface of the desired column. The model may be formed by hand from stones or bricks, or by any other conventional technique.

Once the model is fabricated, it is covered with a layer of clay on all four sides and the top in the illustrated embodiment. The clay has a composition and consistency similar to that of conventional modeling clay used to make pottery, and it adheres to the model. The thickness of the clay is made as uniform as possible, and is typically about ¾ inches thick. The clay does not cover the bottom of the model in the illustrated embodiment.

Next, four outer panels 26 are formed, by for example spraying a coating of a fiberglass containing resin, such as polyester, onto the clay covered model. The outer panels 26 are preferably formed one at a time, and suitable forms are positioned along the edges and top and bottom to form side and end flanges on each panel. These flanges serve to interconnect the panels in a manner which will become apparent as the description proceeds. The fiberglass/resin coating is allowed to harden, resulting in the formation of a rigid outer panel 26 having a flat central portion which is surrounded by raised flanges.

A top end plate 28 is fabricated by the same technique, and a previously formed bottom end plate 29 is positioned to underlie the model and be attached to the flanges of the outer panels, note FIG. 13.

The flanges of the outer panels 26 and the top and bottom end plates 28, 29 are then drilled, to accommodate bolts for securing the components together, as described below.

The outer panels 26 are then removed one at a time, and the underlying clay is stripped from the model. The removed outer panel is then repositioned with the other outer panels and attached thereto by the bolts which join the adjacent flanges. This forms a void in the area previously occupied by the clay beneath the outer panel which has been removed and replaced, as seen in FIG. 3B. The void is then filled with a rubber-like liner material which is introduced through one or more holes (not shown) which are adjacent the upper flange of each panel. Also, one or more small vent holes (not shown) may be formed adjacent the bottom of each panel. During this filling operation, the assembly is preferably placed in a horizontal position, with the removed and replaced panel facing upwardly, and the liner material flows into all areas of the void between the model and the panel 26. Note in this regard that for the first filling operation, the remaining clay forms the boundary along both sides and top of the void.

Upon hardening, a liner 30 is formed and the inner surface of the liner will thereby be formed as a reverse image of the surface of the model.

The second through fourth outer panels 26 are sequentially removed, with the clay under each panel being stripped, and with the resulting void being filled with the liner material in the above described manner. The top end plate 28 is then removed, and the underlying clay is stripped to form a void which is filled with the liner material, note FIG. 3C.

As seen in FIG. 9, a number of bolts 32 may be mounted in the outer panels 26 to secure the liner to the panels. Each outer panel 26 and its attached liner 30 is referred to herein as a side wall member 34 of the mold and the four side wall members collectively form a peripheral side wall of the mold.

As final steps in fabricating the mold 24, the side wall members 34 and top end plate 28 are separated from each other and removed from the model. Since the liner 30 is fabricated sequentially beneath each outer panel 26 and the top end plate 28, there will be break lines formed between the several sections of the liner, and cutting of the liner is not usually required during this separation operation. The side wall members 34 and top and bottom end plates 28, 29 are then re-assembled by interconnecting the adjacent flanges to form a hollow closed mold, with the inner face of the side wall members 34 of the mold, and the inner face of the top end plate 28, forming a reverse image of the model and thus the surface of the desired final column.

### The Mounting of the Mailbox in the Mold

As best seen in FIGS. 4-6, a mailbox 20 is mounted to extend into the interior of the mold 24. To facilitate the handling of the side wall members 34, two of the side wall members may be joined to form an L-shaped configuration as seen in FIG. 4. This permits the two joined side wall members to stand upright. Also, the conventional flag and hinged front door of the mailbox 20 are initially removed.

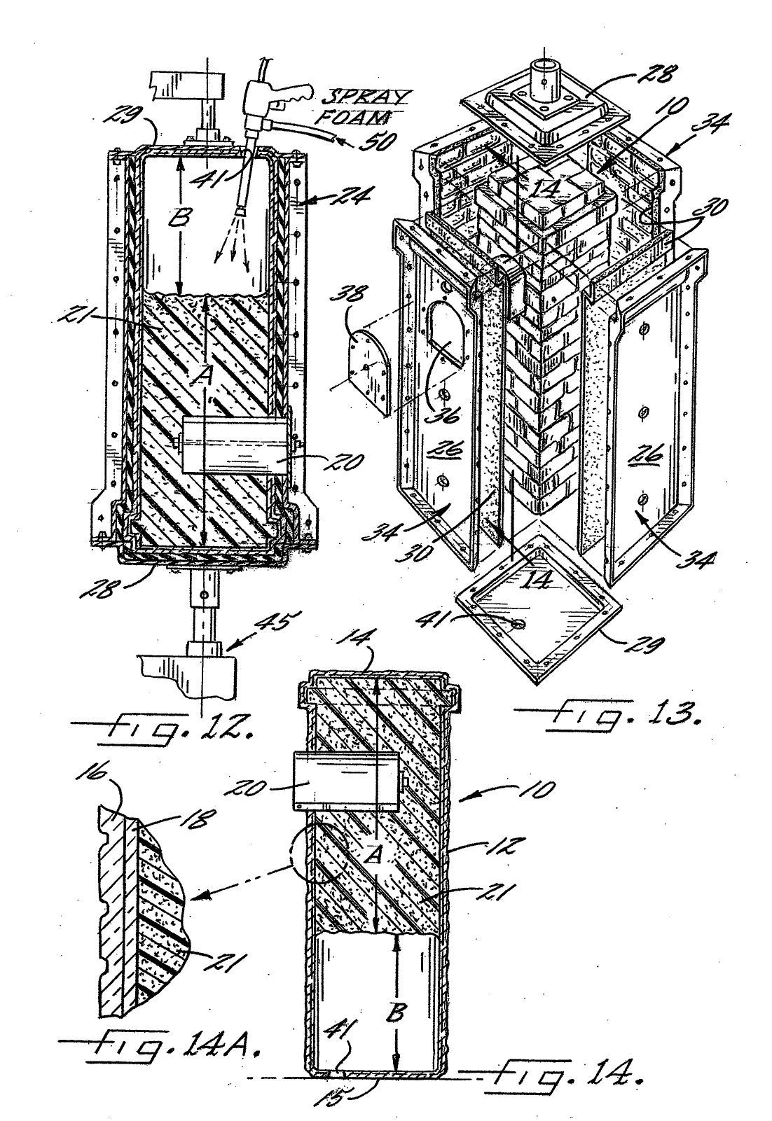

Next, an aperture 36 is cut or otherwise formed which extends through the liner 30 and outer panel 26 of one of the side wall members 34, note FIG. 5, with the aperture 36 having an outline which closely matches the peripheral cross-sectional outline of the mailbox 20. A closure panel or “door” 38 is then attached to the exterior of the outer panel so as to close the aperture, and the mailbox is inserted into the aperture so that its open front end abuts the door 38. A dowel rod 39 is joined to the rear end of the mailbox and extends through and is secured to the outside of the door so as to firmly hold the mailbox in the aperture in the position shown in FIGS. 4 and 5.

While the present embodiment shows a mailbox joined to the interior of the mold, it will be appreciated that a newspaper tube or other similar tubular member can be joined in this fashion.

### The Molding Process

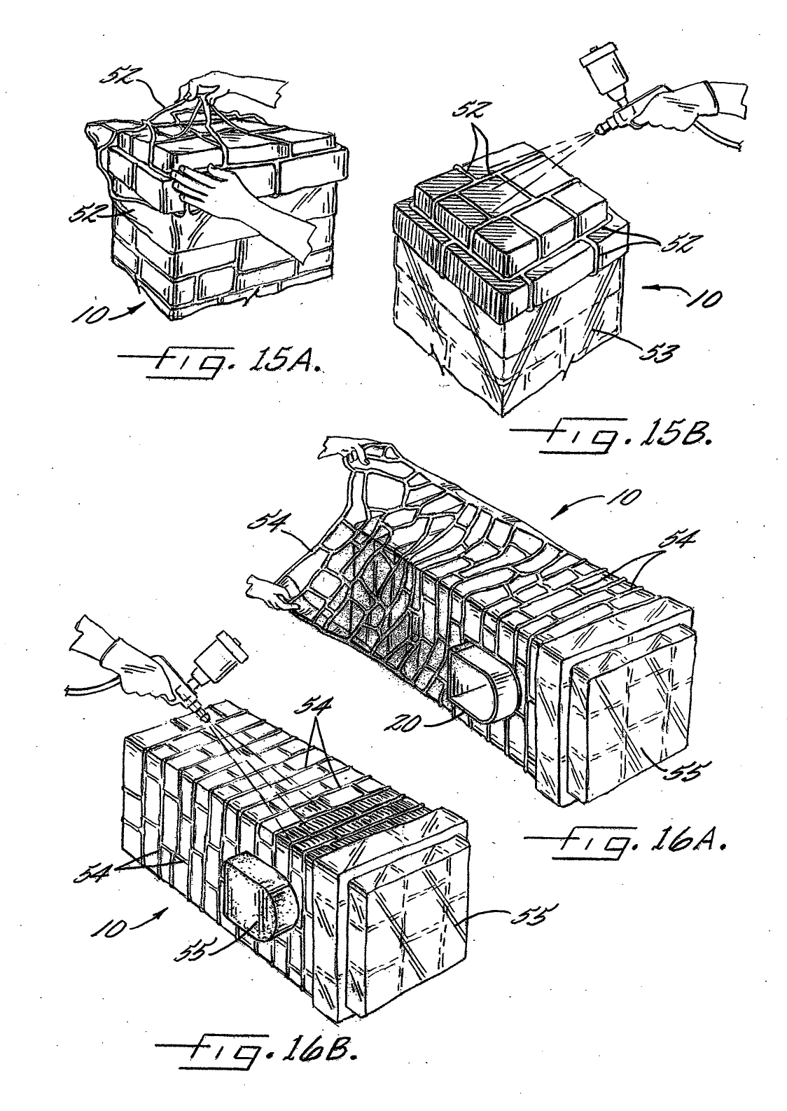

The side wall members 34 and the top and bottom end plates 28, 29 are joined to form a closed mold 24, and the mold is then inverted as shown in FIGS. 6 and 7. A first liquid casting material 40 is then poured into the hollow mold through an aperture 41 in the bottom end plate 29 using a funnel 42. The aperture is then closed with a urethane rubber mold plug 44, which is fitted with a vent (not shown) that prevents the heat generated by the exothermic reaction from pressurizing the interior of the mold during curing. The mold is then mounted on a frame 45 which is configured to simultaneously rotate the mold 24 about two axes which are perpendicular to each other. The minor axis A is set to about six rotations per minute and the major axis B is set to about four rotations per minute.

Such rotation causes the liquid casting material 40, which initially forms a puddle in the bottom of the mold, to flow onto and cover all interior surfaces of the liner 30 on all four side wall members 34 as well as the liner on the top end plate 28 and the bottom plate 29, note FIG. 9. Centrifugal force is not required to effect the coating operation, and thus the low rotational speeds as indicated above are sufficient. The dual rotation typically continues for about 20-22 minutes, and the casting material is then allowed to cool and harden. Upon hardening, the first liquid casting material 40 forms the outer layer 16 (FIG. 14A) of the side wall member 12 of the molded column 10 and as described above. The average thickness of the hardened outer layer 16 is preferably between about 3/32 to 3/16 inches.

A preferred first liquid casting material 40 has the following composition, which is thoroughly mixed before use:

| | First Liquid Coating Material Mix Composition |
|---|---|
| 30 lbs. | Gypsum (Densite HL-GP Gypsum Corp.) |
| 20 lbs. | Sand |
| 15 lbs. | Liquid Resin (Forton VF 812-EPS/CCA) |
| 3 lbs. | Dry Resin (Melamine Formaldehyde |
| | Resin Powder—BTLSR Toledo, Inc.) |
| 68 grams | Ammonium Chloride Hardener (The |
| | Dallas Group of America, Inc.) |
| 4 fluid Ounces | Accelerator (H₂O + Aluminum Sulfate) |
| 504 grams | Pigment—Raw Umber (Kremmer Pigments) |
| 160 grams | Pigment—Black (Kremmer Pigments) |

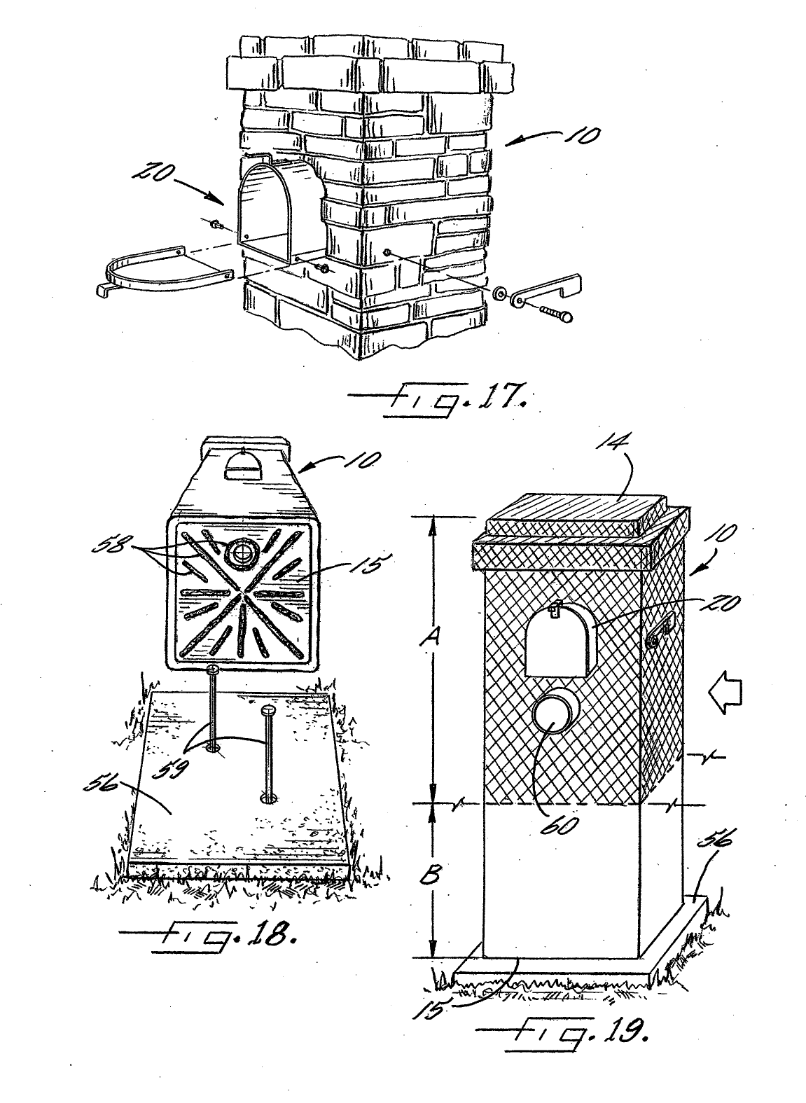

After the first liquid casting material has set up and hardened in the mold 24, a second liquid casting material 48 is mixed and introduced into the mold via the same aperture 41 in the bottom end plate 29, note FIG. 10. The aperture is closed with the plug 44 and the mold is then rotated about the same two axes (FIG. 11) so as to cause the second liquid casting material to move outwardly and coat the hardened first material, i.e. the outer layer 16. This dual rotation typically continues for about 13 minutes, and the second material is then allowed to harden. Upon hardening, the second liquid casting material 48 forms the inner layer 18 (FIG. 14A) of the side wall member of the molded column 10, which self adheres to the outer layer 16, and which has an average thickness of between about 3/32 and 3/16 inches.

A preferred second liquid casting material 48 has the following composition:

| | Second Liquid Coating Material Mix Composition |
|---|---|
| 5 quarts | 8033 A Polyurethane (T.A. Davies Co.) |
| 5 quarts | 8033 B Polyurethane (T.A. Davies Co.) |
| 10 grams | Chopped Fiberglass strands |

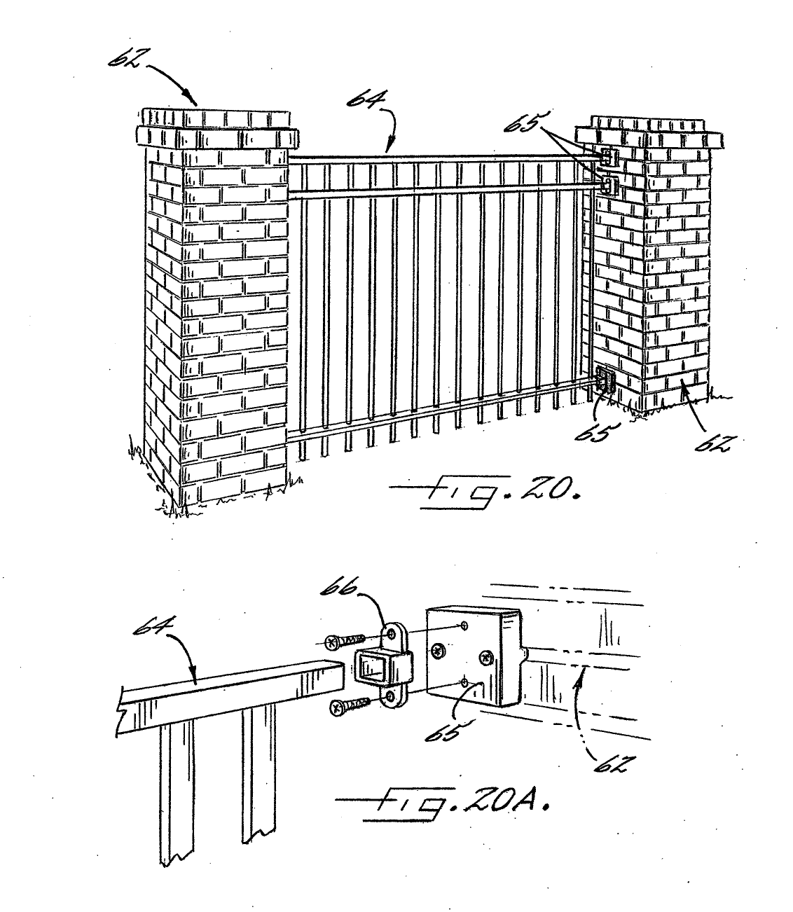

In a preferred embodiment, the mold 24 is next moved to an inverted position and held in this position while a foam forming composition 50 is delivered into the mold through the aperture 41 in the bottom end plate 29. The resulting foam 21 typically surrounds and supports the mailbox 20, and occupies about ⅔ of the height of the inverted mold as represented by the letter A in FIG. 12. The remaining portion of the height which is represented by the letter B, remains open.

A preferred foam forming composition comprises:
½ gal. polymeric isocyanate—A
½ gal. Polyurethane Foam Resin—B
(Instapak FLOWRITE—Sealed Air)

Finally, after the foam composition 50 has cured to form the foam 21, the mold 24 is moved to its upright orientation and the side wall members 34 and top and bottom end plates 28, 29 are separated, note FIG. 13. At this point, it should be noted that the liners 30 adhere to the rigid outer panels 26, and the same components can be used to form additional molded columns without forming new liners. However, the liners can be stripped from the outer panels and new liners can be formed by the process described above, if the liners become damaged or otherwise need to replaced after one or more columns have been molded.

The molded column 10 has the appearance as shown in FIG. 14 at this point. The corner edges of the product may contain flashings formed by excess material where the mold panels are joined together, and if necessary such flashings can be removed by use of a hand chisel.

### The Finishing of the Molded Product

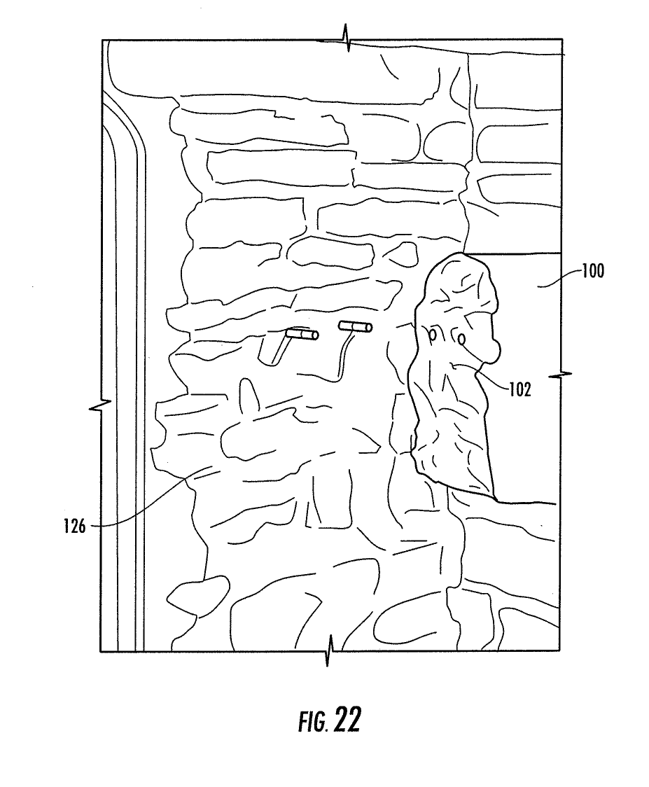

To highlight the appearance of stones in the illustrated embodiment, the top portion of the molded column 10 is spray painted with one or more colors. First, the top portion is covered with a rubber-like stencil 52 which is configured to match the outline of the grout lines between the stones, note FIG. 15A. The remaining portion of the column is wrapped with a protective sheeting 53, and a base coat is applied to the top portion of the column by spraying. When it has dried, one or more highlight colors may be applied by spraying. Typically, the base coat is sprayed over the entire top portion, and the next colors are sporadically applied to highlight particular “stones”. The stencil 52 and protective sheeting 53 are then removed.

The molded column 10 is then laid horizontally upon a suitable dolly (not shown), and a rubber-like stencil 54 is applied to cover the grout lines on two sides of the column. The top portion of the column and mailbox opening are covered with a protective wrap 55. These two sides are then spray painted as described above, and the product is rotated through 180° to expose the other two sides, which are then similarly covered with a stencil 54 and spray painted, note FIGS. 16A and 16B.

The stencils 52, 54 for the top portion of the column and the sides of the column may be initially fabricated by extruding a line of urethane rubber composition along the grout lines using a caulking gun. Upon hardening, a rubber-like network is produced which conforms closely to the grout lines. Once formed, the stencils can be re-used with a number of molded columns which are produced in the same mold.

The last step in the finishing process is to spray the entire column 10 with a sealer. This prevents moisture intrusion and lengthens the life of the paint. The protective wrap 55 is preferably retained on the mailbox during the spraying operation.

As shown in FIG. 17, the front door and the flag of the mailbox 20 are then re-attached to the box and the column respectively.

### Assembly at Final Location

The finished column 10 and integral mailbox 20 are adapted to be easily mounted upon a cement foundation footer 56 as seen in FIGS. 18 and 19. The lower surface of the bottom end wall 15 of the column is preferably smooth and flat, resulting from the smooth and flat interior surface of the bottom end plate 29 of the mold, note FIG. 13. As a result, a suitable adhesive 58 can be applied to the bottom end surface, and/or the footer, so as to securely support the column 10 when it is mounted upon the footer and the adhesive dries. One or more upright bolts 59 can be mounted to extend upwardly through the footer and also through apertures (not shown) formed in the bottom end wall of the column, to further support the column if desired.

FIG. 19 is a schematic representation which indicates that the upper ⅔ of the column 10 is filled with the foam 21 and is thus relatively solid, while the lower ⅓ is hollow. The hollow and relatively weak bottom third permits the column to easily break apart or break away from the foundation footer 56 upon accidental impact, such as by an automobile. The damage to an automobile which impacts the column would thereby be minimized.

The embodiment of FIG. 19 also includes a hollow newspaper tube 60 which can be mounted in the column as described above with respect to the mailbox.

### The Fencepost Embodiment

The features and advantages of the present invention can be achieved with a number of products in addition to a mailbox supporting column as described above. For example, and as illustrated in FIGS. 20 and 20A, the invention can be employed to fabricate a simulated brick fencepost 62. In this embodiment, a railing 64 can be easily joined between adjacent fenceposts, utilizing a plurality of mounting pads 65 which are shaped to match the contour of the “stones”, or in this case the “bricks”, and mounting brackets 66. In this embodiment, the presence of interior foam is most likely unnecessary, and the entire interior of the fencepost 62 could be hollow.

### Alternative Embodiment of Simulated Stone/Brick Mailbox Column

The above-described embodiments of a simulated stone or brick column or fencepost have a two-layer structure in which a first layer is rotationally cast in the mold using a first liquid casting composition, after which a second layer is rotationally cast using a second liquid casting composition that is different from the first liquid casting composition. In particular, in order to achieve adequate strength properties of the column while also achieving the realistic appearance of a stone or brick column (including all of the very fine detail that a real stone or brick column would have, as reflected in the mold made from a real stone/brick column), it was necessary to employ one type of casting composition suitable for achieving the desired fine detail, which formed the first or outer layer of the column, and then to employ another different type of casting composition having substantial strength properties, which formed the second or inner layer of the column. Specifically, as described in a preferred embodiment above, the second casting composition found to be particularly suitable comprised a polyurethane composition containing chopped fiberglass strands.

The alternative embodiment described now differs from the previous embodiment in that the column is made as a single layer of a single type of liquid casting material. The casting material employed in this embodiment is able simultaneously to achieve the desired fine detail in the outer surface of the column and to provide the requisite strength properties, which previously had been thought to be achievable only by including the fiber-reinforced polyurethane layer.

The liquid casting material in accordance with this embodiment is composed of a blend of a polymer resin component, a catalyst component that, when blended with the polymer resin component, initiates an exothermic chemical reaction that ultimately results in the casting material curing and hardening, and a filler component distributed throughout the casting material. The polymer resin component can be one or more ester resins such as polyester resin or vinyl ester resin or the like. To achieve the desired degree of rigidity of the column without excessive brittleness, the resin component can be a blend of a rigid ester resin and a flexible ester resin. The catalyst component can comprise methyl ethyl ketone peroxide (MEKP) or the like.

The filler component can comprise one or more of inorganic particulate fillers (e.g., calcium carbonate, aluminum trihydrate, or the like), organic particulate fillers (e.g., pulverized pecan shells, wood flour, or the like), or lightweight microballoons or microspheres (e.g., glass microballoons, phenolic resin microballoons, or the like). The inclusion of microballoons largely contributes to the surprisingly lightweight nature of the finished column, while still achieving the needed strength.

The casting material can also include additives such as a defoaming or air-releasing agent to substantially prevent the formation of air bubbles in the exterior surface of the casting, a thinning agent or solvent to achieve the desired degree of fluidity of the material, a pigment (e.g., titanium dioxide or the like), etc.

In one embodiment, the casting material comprises, by weight, approximately 60-65% polyester resin, approximately 30-35% filler, and approximately 1% MEKP catalyst, with the balance being made up of additives as noted above. Notably, the casting material is free of any fibrous reinforcing material such as fiberglass or the like.

The alternative embodiment also differs from the previous embodiment in the way in which a mailbox-accommodating receptacle and a newspaper tube-accommodating receptacle are formed in the column. In particular, a mailbox mold plug 100 (FIG. 21) is fabricated that forms an appropriate mailbox-shaped opening and sleeve that later accommodates an “off the shelf” mailbox container. The mailbox mold plug 100 is a mailbox-shaped removable and reusable appendage that closely matches the peripheral cross-section outline of a suitable mailbox container and also has a mating face 102 (FIG. 22) that has a profile complementary to the simulated stone/brick profile of the side wall member of the mold, so that gaps between the two members are substantially prevented.

The first step in fabricating the mailbox mold plug 100 is to build a rigid core that closely resembles the overall size and shape of the desired finished plug while allowing for an approximately ½ inch-thick outer coating to be applied later in the process. The rigid core is then equipped with two heavy-duty threaded inserts that are positioned in the mating face of the plug (FIG. 22) so as to provide a repeatable and reliable means of attaching the plug to the inner face of the side wall member. With the appropriate attachment bolts adequately treated with a releasing agent and properly engaged in the threaded inserts of the plug, an outer silicone rubber coating is then poured around the core, resulting in a continuous evenly distributed layer of silicone rubber material covering all surfaces of the core except the two through holes formed by the attachment bolts.

It should be understood that the mailbox mold plug 100 need not have a length equal to the length of the mailbox, and in fact it is preferred for the mailbox mold plug to have a substantially shorter length as shown in the drawings.

It is also to be understood that a newspaper tube mold plug 110 (FIG. 21) can be fabricated and used in the same general manner as described above with respect to the mailbox mold plug. Like the mailbox mold plug, the newspaper tube mold plug 110 also includes a mating face having a profile that is complementary to the simulated stone/brick profile of the side wall of the mold. Unlike the mailbox mold plug, however, the newspaper tube mold plug advantageously (but not necessarily) has a length corresponding to the length of a standard newspaper tube.

### The Molding Process

With reference to FIGS. 21 and 22, to facilitate the handling of the side wall members of the mold, two side wall members 126 are joined to form an L-shaped configuration. This permits the two joined side wall members 126 to stand upright.

Next, the mailbox mold plug 100 is attached to the appropriate side wall 126 via two hex head bolts threaded into the threaded inserts in the plug. When a newspaper tube is also to be included, a newspaper tube mold plug 110 is attached to the side wall in the same manner.

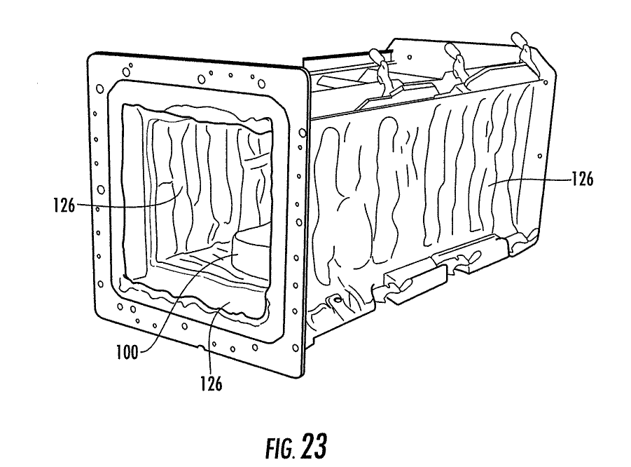

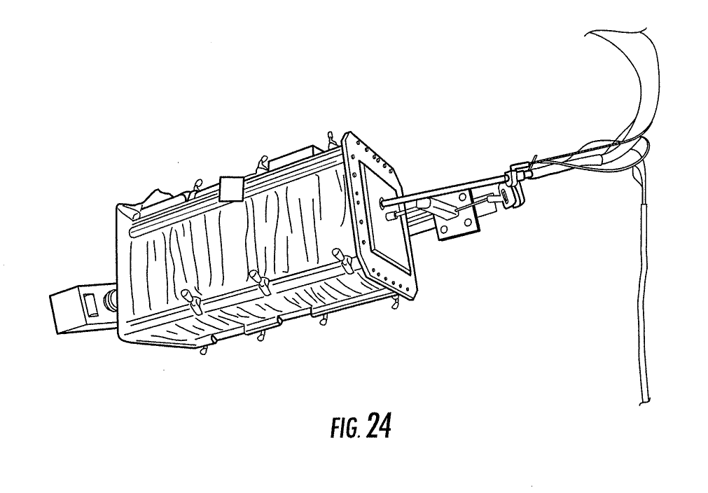

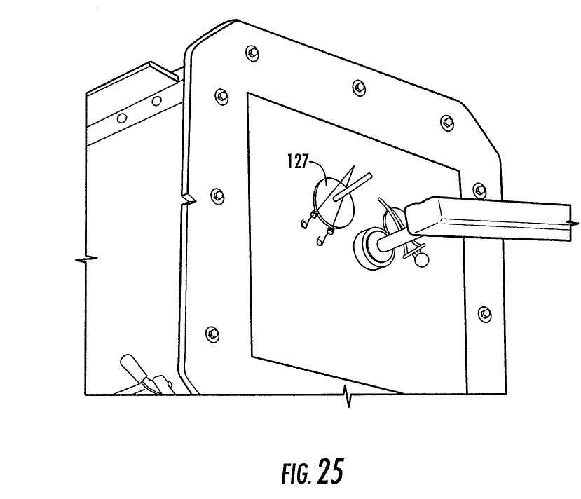

The remaining side wall members 126 are joined (FIG. 23) and the top and bottom wall members are attached to form a closed mold, and the mold is then mounted on a frame that is configured to simultaneously rotate the mold about two axes that are perpendicular to each other (FIG. 24). The mold is oriented in a horizontal position for filling. The liquid casting material is then injected into the hollow mold through an aperture in the bottom wall member using a resin dispensing system that brings the catalyst component and the other components together and mixes them just prior to introducing the material into the mold (FIG. 24). The aperture in the bottom wall is then closed with a silicone rubber stopper 127 (FIG. 25), which is fitted with a vent that prevents the heat and gases generated by the exothermic reaction from pressurizing the interior of the mold during curing. The mold is then set into motion at about 13 rotations per minute on the major axis (end over end) and about 22 rotations per minute on the minor/secondary axis.

Such rotation causes the liquid casting material, which initially forms a puddle in the lowest points of the mold, to flow onto and cover all interior surfaces of the liner on all four side wall members 126 as well as the liner on the top and bottom wall members. The liquid casting material also coats the exterior surfaces of the mailbox mold plug 100 and newspaper tube mold plug 110 and forms respective openings and sleeves in the molded column having perimeters corresponding to the exterior shapes of the mailbox and newspaper tube, respectively. Centrifugal force is not required to effect the coating operation, and thus the low rotational speeds as indicated above are sufficient. The dual rotation typically continues for about 20-25 minutes, allowing the casting material to harden. The average thickness of the hardened layer is ⅜ inches.

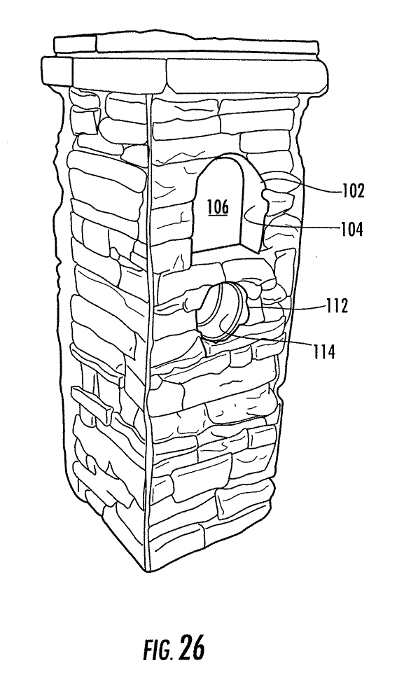

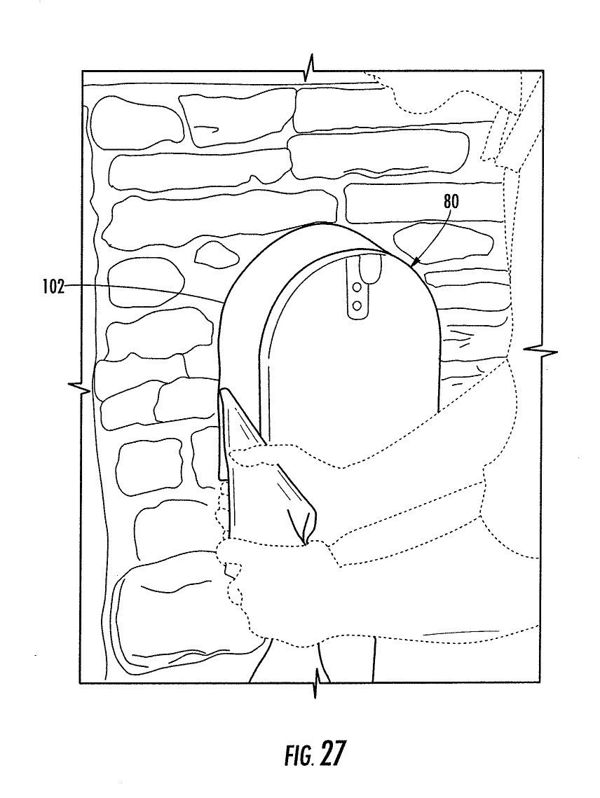

The mold is then removed from the rotational frame and disassembled, revealing the completed casting (FIG. 26). One full cycle (assembling the mold, injecting the casting material, rotating the mold, removing the mold from the rotational frame, and disassembling the mold) generally takes about 45 minutes.

The coating of the mailbox mold plug 100 by the casting material results in the molded column having a mailbox-shaped opening 102 and sleeve 104 extending through the peripheral side wall into the hollow interior of the molded column. Since the mailbox mold plug has a length substantially shorter than the mailbox, the sleeve 104 likewise has a length substantially shorter than the mailbox length. Once the bottom wall 106 of this sleeve is removed by a suitable cutting tool, the result is an opening 102 and sleeve 104 extending through the peripheral side wall of the column for receiving a mailbox.

Similarly, the coating of the newspaper tube mold 110 plug by the casting material results in the molded column having a newspaper tube-shaped opening 112 and sleeve 114 extending through the peripheral side wall into the hollow interior of the molded column.

Along the corner edges of the column where the mold panels are joined together, flashings may be formed by excess material and therefore must be removed by use of a hand chisel or suitable rotary tool prior to finishing.

Finally, a residual film that forms on the casting as a result of the exothermic chemical reaction must be removed by use of a hot water pressure-washing system or other suitable means prior to finishing.

### Mounting the Mailbox Container

Prior to finishing, a suitable mailbox container must be mounted in the mailbox-shaped opening that was cast into the column earlier in the fabrication process. The mailbox container 80 is slid into the opening 102 (FIG. 27) and then secured with an inward-facing bolt that is imbedded into the column side that abuts the rear of the mailbox container, which is predrilled with a suitable through hole to receive the bolt.

Once the mailbox container 80 is secured to the column, a clearance gap between the mailbox container and the opening 102 in the side of the column must be filled by way of a conventional grouting technique, which involves squeezing a cement-based material through a cone-shaped bag, filling the void between the molded column and the mailbox (FIG. 27). Upon initial signs of hardening, the extruded material may then be tooled and shaped to provide the customary look of masonry.

A standard newspaper tube (not shown) is installed in the opening 112 and sleeve 114 formed by the newspaper tube mold plug 110, in the same general manner as described above with respect to the mailbox container, so that an open end of the newspaper tube is accessible through the opening 112 in the peripheral side wall.

### Finishing of the Simulated Stone/Brick Column

To create the authentic appearance of stone or brick, the column is spray painted with one or more colors.

Throughout the entire finishing process, the column can be stood in the natural upright position and placed on a hydraulic scissor lift table equipped with a 360 degree rotating platen, allowing for the column to be oriented and manipulated with minimal physical effort.

First, a tinted primer/bonding coat is applied over the entire column, which sets the general undertone of the finish. Once the primer coat has dried, in order to establish a firm base, a second coat of conventional paint tinted the same color as the primer coat is applied over the entire column. When the second coat has dried, the entire column is systematically sprayed with a contrasting color of conventional paint and then quickly rubbed with a damp cloth before the paint is allowed to dry, allowing the underlying contrasting color to bleed through, which creates authentic-looking veining and simulates weather-imposed details. After drying, one or more highlight colors of conventional paint are applied sporadically around the entire column to highlight particular “stones”.

The last step in the finishing process is to spray the entire column with a sealer preventing both moisture intrusion and weather-related damage as well as UV degradation.

The simulated stone column is installed at a field site in substantially the same manner as described above in connection with the first embodiment.

Many modifications and other embodiments of the invention set forth herein will come to mind to one skilled in the art to which the invention pertains having the benefit of the teachings presented in the foregoing description and the associated drawings. While the invention has been described herein as being useful as a support for a plaque, light, or mailbox, or as a fence post, other uses are possible. For example, the column could be formed to surround and thus provide an ornamental outer cover for a structural beam or piling. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of fabricating a simulated stone or brick column, comprising the steps of:
providing a hollow closed mold having a peripheral side wall and opposite end plates, with at least the peripheral side wall having an inner face formed as a reverse image of a stone or brick surface;
introducing a liquid casting material into the mold, the liquid casting material comprising a polymer resin component blended with a catalyst component and having a filler component distributed throughout the liquid casting material, wherein the catalyst component is added to a mixture of the polymer resin and filler components just prior to introducing the liquid casting material into the mold, and wherein the casting material is free of any fibrous reinforcing material;
rotating the mold about two different axes to cause the liquid casting material to coat the inner face of the side wall and the opposite end plates of the mold;
allowing the liquid casting material to cure and harden; and
opening the mold and removing the resulting molded column therefrom, wherein the resulting molded column comprises a peripheral side wall and upper and bottom end walls, with at least the peripheral side wall of the molded column having an exterior surface in the form of a positive image of the stone or brick surface.

2. The method of claim 1, wherein the filler component of the liquid casting material includes at least microballoons.

3. The method of claim 1, comprising the further step of installing a mailbox in the peripheral side wall of the molded column so that an openable end portion of the mailbox extends through an opening in the peripheral side wall.

4. The method of claim 3, comprising the further step of forming the opening in the peripheral side wall for the mailbox by attaching a mailbox mold plug to the inner face of one of the side wall members of the mold prior to introducing the liquid casting material into the mold, the mailbox mold plug having an exterior surface simulating an exterior shape of the mailbox, such that during the step of rotating the mold the liquid casting material coats the exterior surface of the mailbox mold plug and forms a recess in the molded column having a perimeter corresponding to the exterior shape of the mailbox.

5. The method of claim 4, wherein the mailbox mold plug has a face that abuts the inner face of the side wall member of the mold, and the face of the mailbox mold plug has a profile that is complementary to the reverse image of the stone or brick surface defined by the inner face of the side wall member so as to substantially prevent any gap between the face of the mailbox mold plug and the inner face of the side wall member.

6. The method of claim 5, wherein the mailbox mold plug has a length substantially shorter than a length of the mailbox.

7. The method of claim 4, comprising the further step of installing a standard newspaper tube in an opening in the peripheral side wall of the molded column so that an open end of the newspaper tube is accessible through the opening in the peripheral side wall.

8. The method of claim 7, comprising the further step of forming the opening in the peripheral side wall for the standard newspaper tube by attaching a newspaper tube mold plug to the inner face of said one of the side wall members of the mold prior to introducing the liquid casting material into the mold, the newspaper tube mold plug having an exterior surface simulating an exterior shape of the standard newspaper tube, such that during the step of rotating the mold the liquid casting material coats the exterior surface of the newspaper tube mold plug and forms the opening in the molded column having a perimeter corresponding to the exterior shape of the standard newspaper tube.

9. The method of claim 8, wherein the newspaper tube mold plug has a face that abuts the inner face of the side wall member of the mold, and the face of the newspaper tube mold plug has a profile that is complementary to the reverse image of the stone or brick surface defined by the inner face of the side wall member so as to substantially prevent any gap between the face of the newspaper tube mold plug and the inner face of the side wall member.

10. A simulated stone or brick column, comprising:
a rotary-cast member having a peripheral side wall and opposite end walls surrounding a hollow interior of said member, an exterior surface of at least the peripheral side wall having a realistic look and texture of stone or brick, the hollow member being formed of an initially liquid casting material comprising a polymer resin component blended with a catalyst component and having a filler component distributed throughout the liquid casting material, wherein the filler component includes at least microballoons, and wherein the casting material is free of any fibrous reinforcing material.

11. The simulated stone or brick column of claim 10, wherein the polymer resin component comprises one or more of polyester resin and vinyl ester resin.

12. The simulated stone or brick column of claim 11, wherein the catalyst component comprises methyl ethyl ketone peroxide.

13. The simulated stone or brick column of claim 11, wherein the filler component additionally includes one or more of inorganic particulate filler and organic particulate filler.

14. The simulated stone or brick column of claim 13, wherein the microballoons comprise glass microballoons.

15. The simulated stone or brick column of claim 10, further comprising a mailbox-shaped opening and sleeve extending through the peripheral side wall into the hollow interior of the molded column, the sleeve having a length substantially shorter than a mailbox length.

16. The simulated stone or brick column of claim 15, further comprising a mailbox installed in the mailbox-shaped opening and sleeve.

17. The simulated stone or brick column of claim 15, further comprising a newspaper tube-shaped opening and sleeve extending through the peripheral side wall into the hollow interior of the molded column.

18. The simulated stone or brick column of claim 17, further comprising a standard newspaper tube installed in the newspaper tube-shaped opening and sleeve.
